(19) United States
(12) Patent Application Publication
(10) Pub. No.: US 2004/0143366 A1
(43) Pub. Date: Jul. 22, 2004

(54) Shipment management system and method

(76) Inventor: Ming-Fang Tsai, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/748,813

(22) Filed: Dec. 29, 2003

(30) Foreign Application Priority Data
Dec. 25, 2002 (TW) 91137239

(51) Int. Cl. G06F 7/00

(52) U.S. Cl. 700/213

(57) ABSTRACT

A shipment management system includes a shipment management server (1), a database (2), a network (3), and a plurality of client computers (4). The shipment management server includes a basic data receiving module (10) for receiving basic data; a product warehousing module (11) for warehousing products; a shipment sheet generating module (12) for determining clients to which products are shipped, shipping dates, and generating shipment sheets; a shipment sheet processing module (13) for collecting shipment sheets, generating an accumulative shipment sheet for each client, and arranging for packing of products to be shipped; a shipment confirming module (14) for confirming shipment, and transmitting the confirmation of shipment to an external system (5); and a report generating module (15) for generating shipment reports. A related shipment management method is also disclosed.

### BACKGROUND OF THE INVENTION

1. Field of the Invention

The present invention relates to shipment management systems and methods, and particularly to a computer-enabled shipment management system and method that can automatically manage shipment taking into consideration sales return products.

2. Background of the Invention

In today's highly competitive commercial environment, the requirement that products be manufactured for the least possible cost is important for manufacturing enterprises, especially large-scale manufacturing enterprises that do business around the world. There are numerous methods that can systematically reduce costs. One important and efficient method is to optimize a computerized management system.

For a typical large-scale manufacturing enterprise, there are a number of management sub-systems comprised in the computerized management system. These may include an inventory management sub-system, a procurement sub-management system, and a shipment management sub-system. Traditionally, most shipment procedures are handled manually. However, labor costs are frequently high, and such operations are generally very time-consuming. With the recent development of computer science and network technology, shipment management methods that are based on the Internet are becoming more and more popular in manufacturing enterprises, because of their simple processes, lower error rates, and lower cost. However, the above-mentioned methods generally only take into account shipment for finished products, and do not provide the capability for managing shipment of sales return products.

There is no known shipment management system and method which not only automatically manages shipment for finished products, but also manages shipment for sales return products which are regarded as finished products.

### SUMMARY OF THE INVENTION

Accordingly, a main object of the present invention is to provide a shipment management system and method for automatically managing shipment of products including shipment of sales return products.

In order to accomplish the above-mentioned object, the present invention provides a shipment management system. The system comprises a shipment management server for receiving basic data, determining clients to which products are shipped, shipping dates, generating an accumulative shipment sheet for each client, and transmitting the confirmation of shipment to an external system; a plurality of client computers for providing interactive user interfaces for users to query the basic data and shipment reports; a database for storing the basic data and the shipment reports.

The shipment management server comprises: a basic data receiving module receiving basic data from a sales management sub-system of the external system, a product warehousing module for warehousing products, generating data on warehoused products, and transmitting the data on warehoused products to an inventory management sub-system of the external system; a shipment sheet generating module for determining clients to which products are shipped, shipping dates, and generating shipment sheets; a shipment sheet processing module for collecting shipment sheets, generating an accumulative shipment sheet for each client, generating detailed data on the accumulative shipment sheet, and arranging for packing of products to be shipped according to needs of the client and packing data stored in the database; a shipment confirming module for confirming shipment according to the detailed data on accumulative shipment sheet, and transmitting confirmation of shipment to the external system; and a report generating module for generating shipment reports.

Further, a preferred embodiment of a shipment management method according to the present invention comprises the following steps: (1) receiving basic data; (2) warehousing products, generating data on warehoused products, and transmitting the data to an inventory management sub-system of an external system; (3) determining clients to which products are shipped, shipping dates, and generating shipment sheets; (4) collecting the shipment sheets, generating an accumulative shipment sheet for each client, and arranging for packing of products to be shipped; (5) confirming shipment according to detailed data on the accumulative shipment sheet; (6) transmitting confirmation of shipment to an external system; and (7) generating shipment reports.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of hardware configuration of a shipment management system in accordance with a preferred embodiment of the present invention;

FIG. 2 is a schematic diagram of main software function modules of a shipment management server of FIG. 1;

FIG. 3 is a flowchart of a shipment management method in accordance with the preferred embodiment of the present invention; and

FIG. 4 is a flowchart of a preferred method for warehousing sales return products according to the present invention.

### DETAILED DESCRIPTION OF THE INVENTION

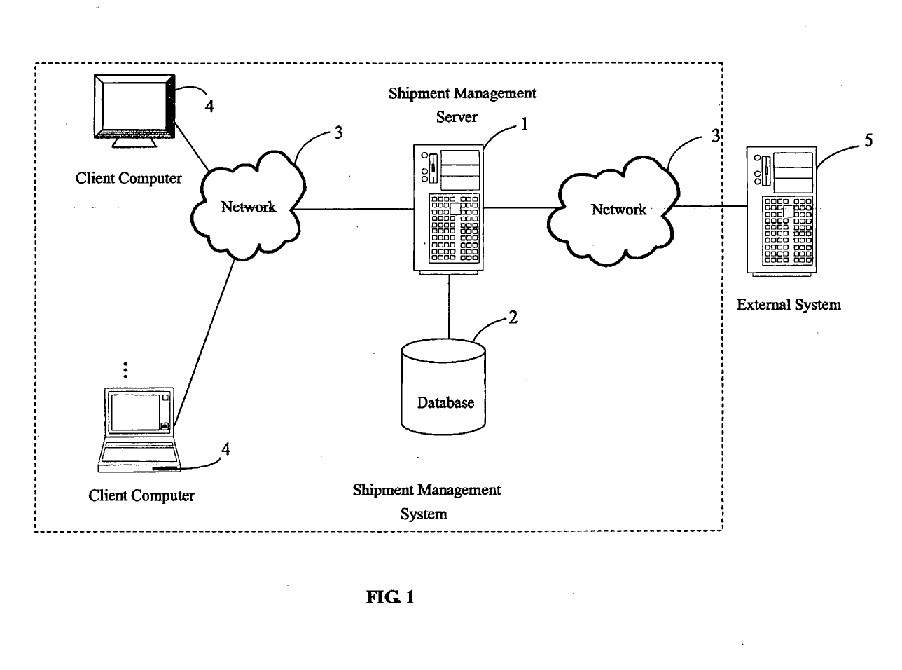

FIG. 1 is a schematic diagram of hardware configuration of a shipment management system in accordance with the preferred embodiment of the present invention. The shipment management system comprises a shipment management server 1, a database 2, a network 3, and a plurality of client computers 4. The shipment management server 1 is used for receiving basic data, determining clients to which products are shipped and shipping dates, generating an accumulative shipment sheet for each client, and transmitting confirmation of shipment to at least one external system 5. The database 2 is used for storing basic data and shipment reports. Each client computer 4 provides an interactive user interface for users to query the basic data and the shipment reports. The external system 5 may include various sub-systems that directly or indirectly relate to the shipment management system, such as a sales management sub-system, an inventory management sub-system, a procurement management sub-system, and an accounts receivable management sub-system.

The shipment management server 1 may utilize a UNIX system, a Windows NT system, or any other desired operating system. The database 2 may be ORACLE 7, ORACLE 8 or any other suitable type of database. The network 3 may be an intranet, the Internet or any other communications network needed for the shipment management system. The client computers 4 may each be installed with Windows 95, Windows 98 or Windows NT. If Windows 95 or Windows 98 is installed, DRAM (dynamic random access memory) is at least 32 MB. If Windows NT is installed, DRAM is at least 64 MB. The client computers 4 are connected to the shipment management server 1 through the network 3.

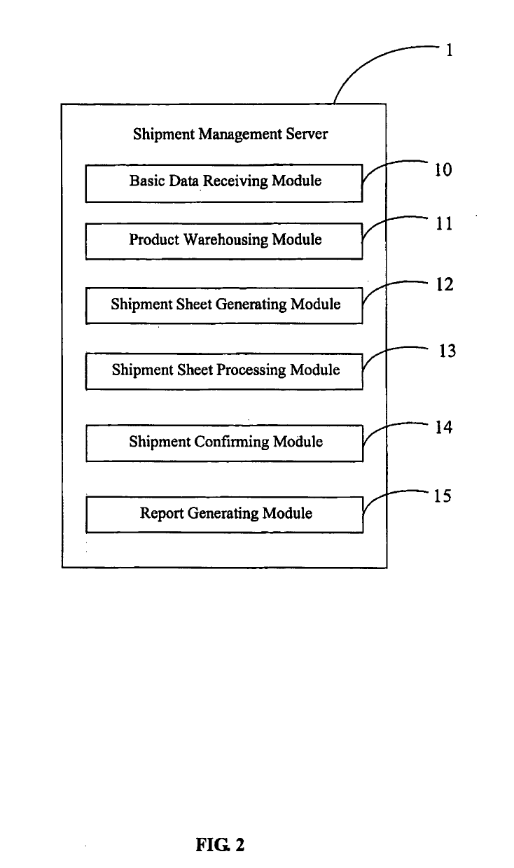

FIG. 2 is a schematic diagram of main software function modules of the shipment management server 1. The shipment management server 1 comprises a basic data receiving module 10, a product warehousing module 11, a shipment sheet generating module 12, a shipment sheet processing module 13, a shipment confirming module 14, and a report generating module 15.

The basic data receiving module 10 is for receiving basic data from the external system 5. The basic data include class codes, basic units, storage areas, part numbers, packing and specifications of products, factory codes, and department codes. The products include work-in-process products, semi-finished products, finished products, and return sales products. The class codes include main class codes and subclass codes. Data on part numbers of products to be warehoused must be input to the shipment management server 1. The class codes of finished products to be warehoused need to be input to the shipment management server 1.

The product warehousing module 11 warehouses products, generates data on warehoused products, and transmits the data on warehoused products to the inventory management sub-system of the external system 5. The shipment sheet generating module 12 is for determining clients to which products are shipped and shipping dates, and generating shipment sheets according to sales orders provided by the sales management sub-system of the external system 5. The shipment sheet processing module 13 is for collecting shipment sheets, generating an accumulative shipment sheet for each client, generating detailed data on the accumulative shipment sheet, and arranging for packing of products to be shipped according to specific needs of the corresponding client and packing data stored in the database 2. The shipment confirming module 14 is used for confirming shipment according to the detailed data on the accumulative shipment sheet, and transmitting confirmation of shipment to the external system 5. The report generating module 15 is for generating shipment reports, and for storing the shipment reports in the database 2.

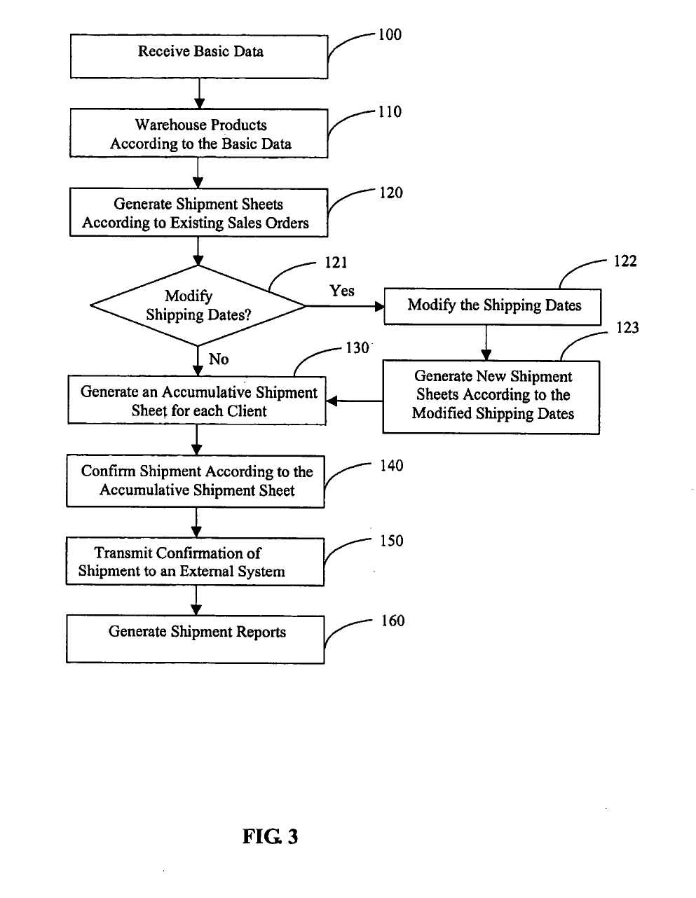

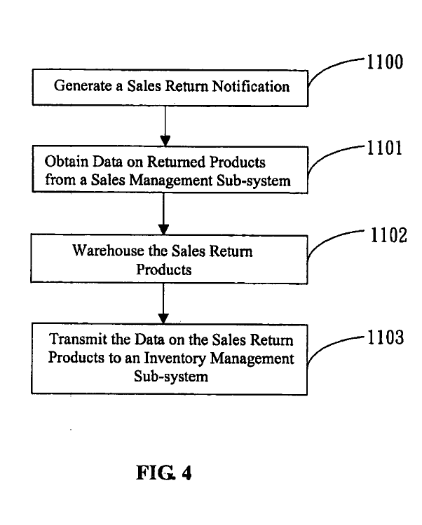

FIG. 3 is a flowchart of a shipment management method in accordance with the preferred embodiment of the present invention. In step S100, the basic data receiving module 10 receives basic data from the external system 5. In step S110, the product warehousing module 11 warehouses products according to the basic data, generates data on the warehoused products, and transmits the data on the warehoused products to the inventory management sub-system of the external system 5. The data on the warehoused products include data on sales return products. (A method of warehousing sales return products is described below in relation to FIG. 4.)

In step S120, the shipment sheet generating module 12 determines clients to which the products are shipped and shipping dates, and generates shipment sheets according to sales orders transmitted by the sales management sub-system of the external system 5. In step S121, the shipment sheet generating module 12 determines whether there is a need to modify shipping dates according to information provided by the sales management sub-system of the external system 5. If there is no need to modify the shipping dates, the procedure goes directly to step S130 described below.

If there is a need to modify the shipping dates, in step S122, the shipment sheet generating module 12 modifies the shipping dates. In step S123, the shipment sheet generating module 12 generates new shipment sheets according to the modified shipping dates. In step S130, the shipment sheet processing module 13 collects all shipment sheets for a same client, and generates an accumulative shipment sheet for the client. Then, the shipment sheet processing module 13 generates detailed data on the accumulative shipment sheet, and arranges for packing of products to be shipped according to specific needs of the client and data on packing stored in the database 2.

In step S140, the shipment confirming module 14 confirms shipment according to the detailed data on the accumulative shipment sheet. In step S150, the shipment confirming module 14 transmits the confirmation of shipment to the external system 5. In step S160, the report generating module 15 generates shipment reports according to the confirmation of shipment, and stores the shipment reports in the database 2.

FIG. 4 is a flowchart of a preferred method for warehousing sales return products, according to the present invention. In step S1100, the sales management sub-system of the external system 5 generates a sales return notification after receiving sales return products, and transmits the sales return notification to the shipment management system. In step S1101, the product warehousing module 11 obtains data on the sales return products from the sales management sub-system of the external system 5 according to the sales return notification. In step S1102, the product warehousing module 11 warehouses the sales return products that are regarded as finished products, and generates detailed data on the sales return products. In step S1103, the shipment management system transmits the detailed data on the warehoused sales return products to the inventory management sub-system of the external system 5. The inventory management sub-system generates inventory variation data and updates a corresponding database.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A shipment management system for automatically managing shipment, the shipment management system comprising:
a shipment management server comprising:
a product warehousing module for warehousing products, generating data on warehoused products, and transmitting the data on warehoused products to at least one external system;
a shipment sheet generating module for determining clients to which products are shipped and shipping dates, and generating shipment sheets according to sales orders provided by said external system;
a shipment sheet processing module for collecting shipment sheets, generating an accumulative shipment sheet for each client, generating detailed data on the accumulative shipment sheet, and arranging for packing of products to be shipped; and
a shipment confirming module for confirming shipment according to the detailed data on the accumulative shipment sheet, and transmitting the confirmation of shipment to said external system;
a database for storing basic data and shipment reports; and
a plurality of client computers for providing interactive user interfaces for users to query the basic data and the shipment reports.

2. The shipment management system as claimed in claim 1, wherein the products comprise any one or more of work-in-process products, semi-finished products, finished products, and sales return products.

3. The shipment management system as claimed in claim 1, further comprising a basic data receiving module for receiving basic data from said external system.

4. The shipment management system as claimed in claim 1, further comprising a report generating module for generating shipment reports.

5. A computer-enabled shipment management method comprising the steps of:
warehousing any one or more of work-in-process products, semi-finished products, finished products, and sales return products;
determining clients to which products are shipped and shipping dates, and generating shipment sheets according to sales orders provided by at least one external system;
collecting shipment sheets, generating an accumulative shipment sheet for each client, generating detailed data on the accumulative shipment sheet, and arranging for packing of products to be shipped; and
confirming shipment according to detailed data on each accumulative shipment sheet.

6. The shipment management method as claimed in claim 5, further comprising the step of receiving basic data.

7. The shipment management method as claimed in claim 5, further comprising the step of transmitting the confirmation of shipment to said external system.

8. The shipment management method as claimed in claim 5, wherein the step of warehousing any one or more of work-in-process products, semi-finished products, finished products, and sales return products comprises the step of:
obtaining data on the sales return products from said external system according to a sales return notification provided by said external system.

9. The shipment management method as claimed in claim 5, wherein the step of warehousing any one or more of work-in-process products, semi-finished products, finished products, and sales return products comprises the step of:
warehousing the sales return products that are regarded as finished products, and generating detailed data on the sales return products.

10. The shipment management method as claimed in claim 5, wherein the step of determining clients to which products are shipped and shipping dates, and generating shipment sheets according to sales orders provided by at least one external system comprises the step of:
determining whether there is a need to modify shipping dates, and if there is a need to modify the shipping dates, the shipment sheet generating module modifying the shipping dates, and generating new shipment sheets according to the modified shipping dates.

11. The shipment management method as claimed in claim 5, further comprising the step of generating one or more shipment reports.
